(19) United States
(12) Patent Application Publication
(10) Pub. No.: US 2024/0021106 A1
(43) Pub. Date: Jan. 18, 2024

(54) SYSTEM FOR ORTHOPAEDIC SURGERY TRAINING

(71) Applicant: TACTILE ORTHOPAEDICS INC., CALGARY (CA)

(72) Inventors: Daniel Zahynacz, Calgary (CA); Gwendolyn Morgan, Calgary (CA); Ian K. Lo, Calgary (CA); John Person, Calgary (CA); Carolyn Anglin, Calgary (CA)

(21) Appl. No.: 18/221,059

(22) Filed: Jul. 12, 2023

Related U.S. Application Data
(60) Provisional application No. 63/388,904, filed on Jul. 13, 2022.

(51) Int. Cl. G09B 23/32

(52) U.S. Cl. CPC G09B 23/32

(57) ABSTRACT

A system for orthopaedic surgery training is provided, the system comprising an apparatus for supporting at least one artificial model of a human joint releasably mounted to the apparatus. The system may further comprise at least one artificial model of a human joint for mounting to the apparatus, wherein the joint may comprise a shoulder.

### REFERENCE TO PENDING PRIOR PATENT APPLICATION

This application claims the benefit under 35 U.S.C. 119 (e) of U.S. Provisional Patent Application No. 63/388,904, filed Jul. 13, 2022 by Daniel Zahynacz, et al. for “SYSTEM FOR ORTHOPAEDIC SURGERY TRAINING,” which patent application is hereby incorporated herein by reference.

### FIELD

A system for orthopaedic surgery training is provided. More specifically, a system for use in orthopaedic surgery training on a human joint is provided, the system comprising an improved apparatus for positioning at least one improved artificial model of the joint.

### BACKGROUND

Surgical training outside of the operating room (OR) has many benefits, including the opportunity to learn and practice in a safe environment, complete an entire procedure even at the early stages of training, make deliberate errors to determine how best to recover, practice with different pathologies, discuss different techniques with peers, experts and novices, become proficient in a technique before using it on a patient, reduce operating time, and increase confidence for new learners. The more the experience feels like performing surgery on a patient, the more immersed the user is in the experience, and the better prepared the user can be.

Orthopaedic surgeries are hands-on procedures in which the setup, patient positioning, surgical workflow, operative aesthetics, and intraoperative interactions, including the tactile feel of the instruments interacting with the tissues, play a critical role in the surgery.

Existing opportunities for orthopaedic surgical training outside of the OR primarily include having to practice on either basic synthetic models or cadaveric specimens. The former have limited realism and therefore limited learning opportunities. The latter, in addition to requiring special handling and only being able to be used in specialized facilities, often lack realism themselves since they may lack the anatomical structures or pathologies needed for the training, or have softer bone due to their age, and, importantly, cannot be positioned or manipulated as one would a patient.

Patient positioning in orthopaedic surgeries plays an important role because it affects the ease with which the procedure can be performed, including access to the joint, exposure of the joint, use of the instruments, and how traction or forces are applied.

Current synthetic shoulder models function primarily in a static position, with limited shoulder movement. Surgeries are practiced on the (limited) anatomy, without focusing on the patient positioning. Joints taken from cadaveric specimens for training are likewise usually held in a static position, often in an atypical orientation. Most of the training and skill development occurs on patients.

The shoulder joint is very mobile, with the roughly ball-shaped humeral head rotating and translating on the relatively flat glenoid, which is the most lateral part of the shoulder blade (scapula). The shoulder can rotate in ab/adduction, flexion/extension, and internal/external rotation, and can translate anteroposteriorly, superoinferiorly, and in distraction. Importantly, when intact, the rotator cuff muscles hold the humeral head against the glenoid, providing some stability. The shoulder joint becomes less stable when one or more of these muscles is torn. One of the most common shoulder surgeries is to repair a torn rotator cuff.

Shoulder surgeries include tendon, ligament, cartilage, or bone surgeries. Specific examples of shoulder surgeries include instability repairs, rotator cuff repairs, diagnostic scoping, biceps surgery, decompressions, tendon transfers, bone grafting, fracture repair and shoulder arthroplasty (hemi, total, resurfacing, conventional and reversed). Other joint surgeries, such as for the elbow joint, hip joint, ankle joint, or other joints may also be considered.

For orthopaedic shoulder surgeries, there are two primary patient setups: the “beach chair” position and the “lateral decubitus” position. The positioning setup used is generally based on surgeon preference and training, since there are advantages and disadvantages to each position.

In the beach chair position, the patient is seated on the OR table at angles varying from 30-90° above the horizontal plane with appropriate padding and with the head secured in a headrest (as if they are seated in a semi-reclined chair, similar to a beach chair). The back of the table is reclined based on surgeon preference. The patient's body is secured to the table using towels, bean bags, and straps. The non-operative arm is secured to the patient's abdomen or is attached to a non-operative arm-board. The operative arm can be controlled by a mechanical positioning device, an arm board, or can be hung off the operative side of the table and positioned by a surgical assistant.

In the lateral decubitus position, the patient is placed on the operating room table lying down on their left or right side, with their non-operative arm down. Their body is secured to the table using towels, bean bags and straps. The operative arm is attached to a shoulder positioning device such as a shoulder tower or mechanical positioning arm.

The positioning of the operative arm is controlled by the positioner or through surgical assistants, based on surgeon preference with respect to arm abduction/adduction angle, flexion/extension angle, and internal/external rotation.

A suspension (traction) load is applied in line with the primary axis of the arm to increase access to the shoulder joint. The traction load is applied through weights on a rope or through mechanical means through the positioning arm.

In some cases, additional traction force (secondary or lateral) is applied perpendicular to the arm to raise the humeral head away from the glenoid. This perpendicular force can be applied by placing towels under the arm, having an assistant lift the arm, or using an additional mechanical device.

Intraoperative adjustments are an important part of patient positioning for orthopaedic shoulder surgeries. The arm angles (abduction/adduction, flexion/extension, and internal/external rotation) can all be adjusted during the procedures to access different patient anatomy and injury pathology. Traction loads can be adjusted to change the distraction of the joint. These intraoperative adjustments can be made either in the beach chair or lateral decubitus positions.

Existing physical training systems place little emphasis on simulating and facilitating normal patient positioning requirements or arm movement for shoulder surgeries. Typically, the scapula is fixed rigidly in place and the humerus is left free, which is unlike the operative situation. Also, in most cases only one primary patient positioning setup is accommodated, either lateral decubitus or beach chair but not both. Furthermore, one of the most challenging parts of the surgery, joint access, is ready-made in the model, without needing to manipulate the joint to achieve the desired access. This is not realistic as it does not represent or illustrate the relationship between patient positioning, arm orientation, traction loads, and joint access.

When using cadaveric specimens for training, the beach chair position is the standard setup, which can be frustrating and disorientating for a surgeon who normally operates in the lateral decubitus position. The difference in the joint orientation between lateral decubitus and beach chair is an approximate 90° rotation in the sagittal plane and a 90° rotation about the transverse plane.

Existing physical training systems provide little or no means to make and hold intraoperative positioning adjustments to the operative arm, in the various degrees of freedom. They typically require users to manually adjust and hold the arm which can lead to fatigue and can be difficult to replicate between users.

Existing physical training systems do not provide a means to apply both primary and secondary traction of the operative limb.

Existing physical training system positioners use a vise or thumb screw to secure the model. These fixation methods can be tedious to tighten and leave subjective assessment by the user for when the model is secure.

Cadaveric positioners typically consist of a pedestal vise mounted on a large fluid management tray. The cadaveric specimen itself may require dissection to expose bony anatomy strong enough to be secured in the vise jaws. This preparation for attachments takes time which could instead be used for the surgical training. There is also a risk of the scapula slipping in the vise jaws during the training, or worse, the scapula breaking.

For physical training on the shoulder either a cadaveric specimen or a simulated shoulder model is used to replicate the patient.

Cadaveric specimens include all of the relevant anatomy but come with many disadvantages. They typically have deteriorated soft tissues and bones that do not represent patients and do not function the same as living tissue. Sometimes the state of deterioration is so unrealistic that the intended surgery cannot be completed as planned.

Cadaveric specimens typically do not include the intended pathology of the desired repair for training. As a result, the trainee must replicate the pathology, which takes time and often does not represent the true pathology.

Training with cadaveric specimens comes with biological hazards, which requires special handling, storage, lab use, and instrumentation. The use of cadaveric specimens also poses ethical questions, and in some international markets is regulated or banned completely.

The use of existing simulated shoulder models addresses some of the issues found with cadaveric specimens, but they have additional disadvantages. For example, the shape, feel and form of the skin is not anatomically representative and the material is typically made from a uniform silicone or urethane rubber. This can be limiting when learning proper portal placement as the relevant landmarks can be difficult to find and cutting through the material with a scalpel may feel too elastic or hard.

In some simulated models the skin is not an integral part of the model; instead, an outer shell, often with premade portals, is used to enclose the shoulder model. The simulated muscles are also typically made from uniform silicone or urethane rubber. They do not feel, behave, or cut the same as live muscle tissues.

A critical anatomical feature for surgical training is the musculotendinous junction. In existing simulated training models, this feature is ignored or is replicated by a sudden change of material, compared to a natural blended transition.

The ligaments and capsule of the shoulder are critical for landmarking inside the joint, facilitating pathology, and for facilitating repairs. Current simulated models include some of the relevant ligaments and the joint capsule, but they fail to properly represent the important landmarks, such as the rotator interval capsule opening and the subtle thickening of the capsule for the glenohumeral ligaments.

The ligaments in some existing simulated models can be sutured using typical suturing devices but can tear under normal loading conditions.

The rotator cuff on simulated models is made from similar materials as the ligaments and can be sutured using typical suturing devices, but will often tear under normal loading conditions.

In current simulated models, the articular cartilage on the humerus and glenoid is not always present, and when present it does not have the appropriate hardness or malleable feel.

The bones in the simulated models sometimes do not include both an outer cortical and inner cancellous layer and, when both types of bones are present, the models do not have the appropriate hardness or tactile feel of real bone. These deficiencies in the bone make training for anchor placement difficult.

There remains a need for an improved system for use in orthopaedic surgery training on a joint, such as a shoulder joint, that provides the operator with a smooth positioning experience akin to the mechanical positioning arm used during actual surgery. It is desired that such a system may be stable during use, while allowing for accurate and ergonomic positioning and repositioning without compromising the system, i.e., flexion/extension, abduction/adduction, etc. It is desired that such a system may be readily adjustable and maneuverable/manipulated with the option of being in at least two different surgical positions, e.g., to mimic circumstances where a surgical patient might be in a substantially seated position, such as a beach chair position, or may be lying down, such as in a lateral decubitus position. There also remains a need for an improved artificial model of a joint, such as a shoulder joint, for use in combination with the improved system.

### SUMMARY

According to embodiments, a system for use in orthopaedic surgery training on a joint is provided, the system comprising an apparatus for supporting at least one artificial model of the joint in at least one joint orientation position, and at least one artificial model of the joint, releasably mounted to the apparatus. In some embodiments, the apparatus may be configured for pivotal and rotatable movement of the artificial model within the at least one joint orientation position. The integration of the apparatus and artificial model, separately and together, mimic the experience of working with a patient.

In some embodiments, the apparatus may comprise a base, and a manipulator arm mounted to the base, the manipulator arm configured to rotatably and pivotally receive the at least one artificial model of the joint. In some embodiments, the base may comprise a base plate, a pedestal, and at least one T-bar connector for receiving and securing the manipulator arm. In some embodiments, the T-bar connector comprises at least two attachment posts for receiving and securing the manipulator arm in the at least one joint orientation position.

In some embodiments, the manipulator arm comprises a sleeve for releasably mounting the manipulator arm to the base. In some embodiments, the manipulator arm further comprises a telescoping boom assembly. In some embodiments, the manipulator arm may be rotatably and/or pivotally mounted to the sleeve.

In some embodiments, the system may further comprise at least one quick-release adapter for releasably connecting the at least one artificial model of the joint to the apparatus.

In some embodiments, the artificial model is a human joint. In some embodiments, the human joint is a shoulder joint, and the at least two joint orientation positions may comprise at least a beach chair position and a lateral decubitus position.

According to embodiments, an apparatus for use in orthopaedic surgery training on a joint is provided, the apparatus being operatively compatible with at least one artificial model of the joint. In some embodiments, the apparatus may comprise a base for releasably receiving and securing a manipulator arm. In some embodiments, the manipulator arm may be rotatably and pivotally mounted to the base and may be configured to receive the at least one artificial model of the joint.

In some embodiments, the base of the apparatus may further comprise a base plate, a pedestal, and at least one T-bar connector for receiving and securing the manipulator arm in one of the at least two joint orientation positions. In some embodiments, the T-bar connector may comprise at least two attachment posts.

In some embodiments, the manipulator arm may be rotatably and pivotally mounted to the base. In some embodiments, the manipulator arm may comprise a sleeve for releasably mounting manipulator arm to the base, and a boom assembly.

In some embodiments, the apparatus may further comprise at least one connector for releasably connecting the apparatus to a surface.

According to embodiments, an artificial model for use in orthopaedic surgery training on a joint is provided, the model being operatively compatible with at least one apparatus for adjustably positioning the artificial model. In some embodiments, the model may comprise at least one connector for releasably connecting the model to the apparatus in one of at least two joint positions.

In some embodiments, the joint may be a human joint. In some embodiments, the human joint is a shoulder joint. In some embodiments, the model may comprise, without limitation, one or more layers of artificial skin, fat, bones, muscles, tendons, ligaments, cartilage, and/or connecting soft tissue.

In some embodiments, the shoulder joint may include, without limitation, a rotator interval, a joint capsule, a musculotendinous junction, a tight or loose joint depending on the surgery being trained, a labrum and biceps tendon, and/or bones of different hardnesses.

In some embodiments, the model may comprise at least a scapula bone and a humerus bone, and one of the at least one connectors connects the scapula bone to the apparatus and another one of the at least one connectors connects the humerus bone to the apparatus.

Advantageously, in some embodiments, the present apparatus may be further configured to provide loading conditions on the at least one artificial model to mimic primary traction, secondary traction, flexion/extension, abduction/adduction, or internal/external rotation of the at least one artificial model.

### DESCRIPTION OF THE DRAWINGS

Embodiments of the present disclosure will now be described, by way of example only, with reference to the attached Figures.

FIG. 1 (PRIOR ART) shows a “beach chair” position conventionally used for orthopaedic shoulder surgeries, according to embodiments;

FIG. 2 (PRIOR ART) shows a “lateral decubitus” position conventionally used for orthopaedic shoulder surgeries, according to embodiments;

FIGS. 3A and 3B shows side views of the present system comprising an apparatus or “limb positioner” for supporting and positioning at least one artificial model of a human joint mounted thereon, shown in anterior view (FIG. 3A) and posterior view (FIG. 3B), according to embodiments;

FIG. 4 shows a side perspective view of a first embodiment of the present limb positioner, the positioner comprising a base operably connected to a manipulator arm according to embodiments;

FIG. 5 shows a side perspective view of the base of the limb positioner shown in FIG. 4, according to embodiments;

FIG. 6 shows a side perspective view of the manipulator arm of the limb positioner shown in FIG. 4, according to embodiments;

FIGS. 7A, 7B and 7B shows zoomed-in views of a quick-release connector, the connector shown in a perspective view (FIG. 7A), a side view (FIG. 7B), and a front view (FIG. 7C, taken along lines A-A in FIG. 7B), according to embodiments;

FIGS. 8A and 8B shows a side perspective view of a second embodiment of the present limb positioner, the limb positioner shown configured for a lateral decubitus position in standard view (FIG. 8A) and in exploded view (FIG. 8B), according to embodiments;

FIGS. 9A and 9B shows a side perspective view of a second embodiment of the present limb positioner, the limb positioner shown configured for a beach chair position in standard view (FIG. 9A) and in exploded view (FIG. 9B), according to embodiments;

FIGS. 10A and 10B depicts an artificial model of a human joint (in this case a shoulder joint), shown in anterior view (FIG. 10A) and posterior view (FIG. 10B), according to embodiments;

FIG. 11A depicts the artificial joint model shown in FIG. 10, the model shown with the pectoral muscle being pulled aside to expose the joint in standard view (FIG. 11A), and in zoomed-in view (FIG. 11B), according to embodiments;

FIG. 12 depicts a zoomed-in view of the rotator interval portion of the model shown in FIG. 10, according to embodiments; and

FIG. 13 shows a zoomed-in view of the subacromial space showing a musculotendinous junction of the model shown in FIG. 10, according to embodiments.

### DETAILED DESCRIPTION OF EMBODIMENTS

Broadly, a system for use in orthopaedic surgery training on a human joint is provided. In some embodiments, the system may comprise an apparatus, or “limb positioner”, operably compatible with at least one artificial model of the joint. In embodiments, the at least one artificial model of the joint may be a shoulder joint.

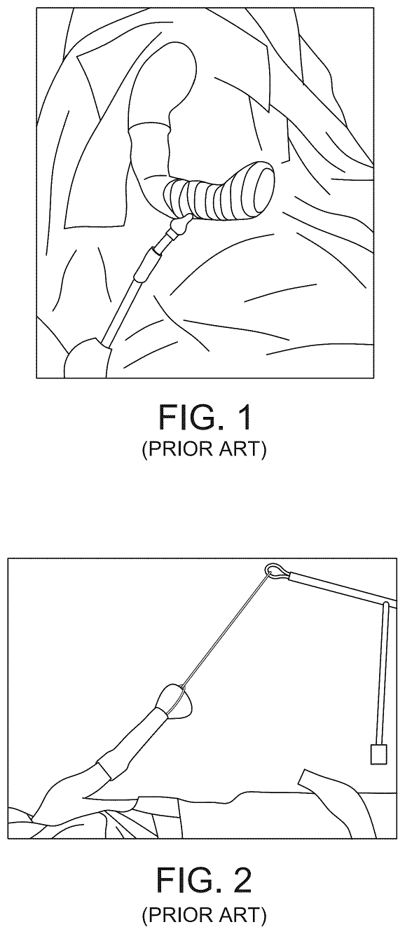

According to embodiments, the system may comprise an apparatus configured to support and position at least one artificial joint model mounted thereto, and advantageously, in various degrees of freedom (e.g., where one element of the model may be dynamically manipulated in various degrees of freedom relative to another portion of the model, without moving the model from its position on the apparatus). For example, advantageously, the present apparatus may be operative to control at least three degrees of freedom of the model. In some embodiments, the apparatus may be configured to support the joint model in one of at least two positions primarily used with patients during orthopaedic surgery. For example, where the model comprises a shoulder joint, the apparatus may be configured such that the shoulder model can be easily maneuvered/manipulated between a first position, mimicking circumstances where the patient might be in a substantially seated position, and a second position, mimicking circumstances where the patient might be in a lying down position. For example, where the artificial joint model comprises a shoulder model, the apparatus may be configured such that the artificial shoulder model may be easily transitioned between a first “beach chair” position (see FIG. 1 PRIOR ART) and a second “lateral decubitus” position (see FIG. 2 PRIOR ART), or vice versa, as desired.

Although reference is made to an artificial model of a shoulder joint, it should be understood that any suitable artificial model of any human or animal joint that is operably compatible with the present apparatus for orthopaedic training purposes is contemplated.

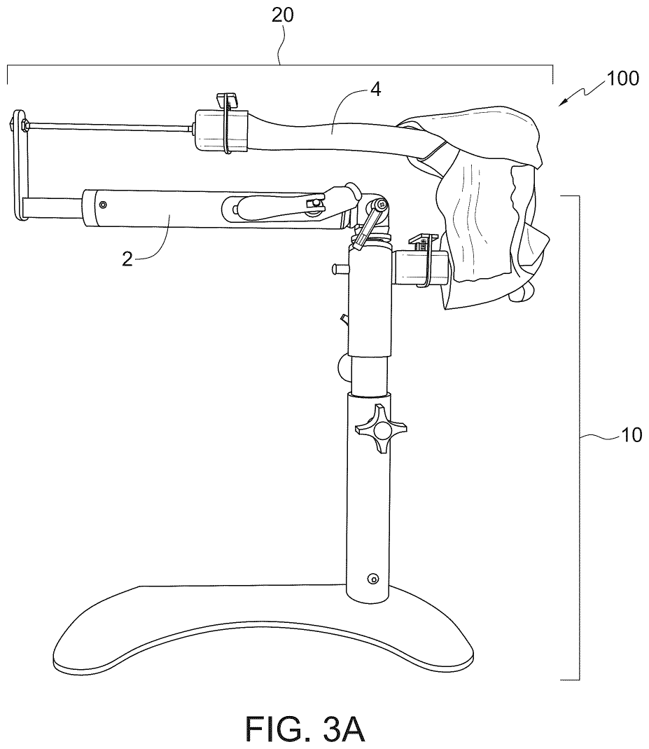

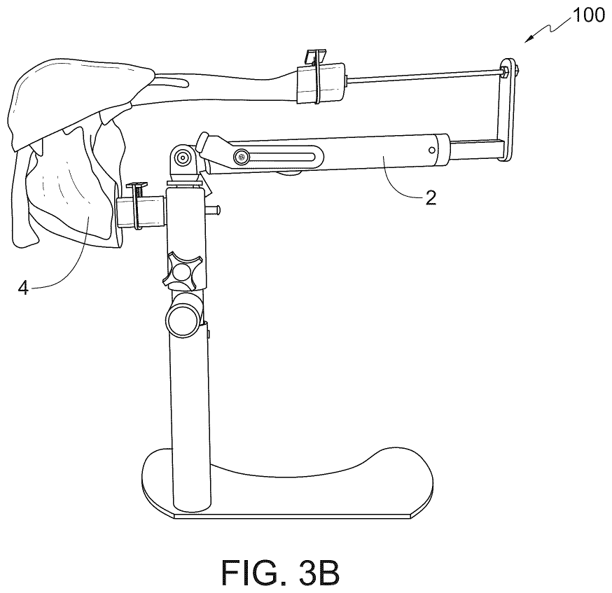

The present system will now be described having regard to FIGS. 3-13.

According to embodiments, having regard to FIGS. 3A and 3B, the present system 100 may comprise an apparatus 2 for positioning a limb, i.e., a “limb positioner”, the apparatus 2 being configured for receiving and supporting the at least one artificial joint model 4 mounted thereon. According to embodiments, apparatus 2 may comprise a base portion 10 and a manipulator “arm” portion 20, the base portion 10 being configured to detachably receive the arm portion 20 in at one of least two joint orientation positions, while still allowing for dynamic interaction with joint model 4 in each of the positions, mimicking actual patient positions conventionally used in an operating room. For example, without limitation, the present apparatus 2 may be advantageously configured to provide both primary traction (e.g., pulling the humerus bone out of the glenoid, perpendicularly to the joint), and secondary traction (e.g., pushing the humerus bone up on the glenoid, parallel to the joint).

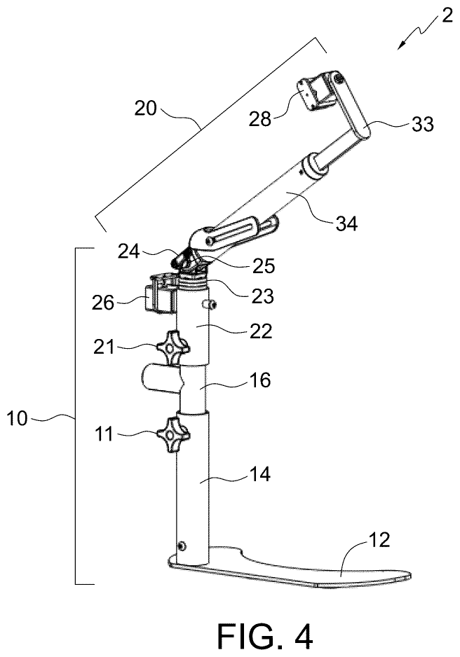

According to embodiments, the base portion 10 of apparatus 2 may be configured to releasably secure apparatus 2 to an operating surface. In some embodiments, having regard to FIGS. 4, 8 and 9, base portion 10 may comprise a base plate 12, a pedestal 14, and an upper T-bar connector 16. In use, base plate 12 serves to secure apparatus 2 to a sturdy work surface, pedestal 14 enables easy height adjustment of apparatus 2, and manipulation of T-bar connector 16 allows the user to select which one of the at least two patient positions is desired.

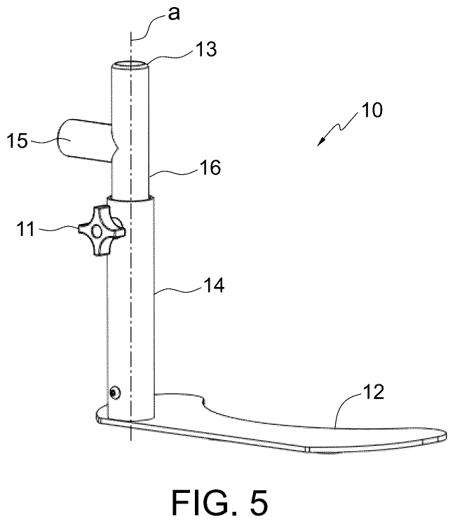

More specifically, having regard to FIG. 5, base plate 12 may be configured for attaching base portion 10 to at least one surface (not shown) with sufficient strength and sturdiness to securely hold “limb positioner” apparatus 2 in place (i.e., such that apparatus 2 does not move when used by an operator for surgical training). Base plate 12 may form a substantially thin, flat, U-shaped member, or any other suitable shape, for securing plate 12 in position on the surface. For example, base plate 12 may be configured for temporary connection to the surface with one or more adjustable attachment devices (e.g., one or more C-clamps). Advantageously, use of one or more adjustable attachment devices ensures base portion 10 can be secured to any variety of surfaces including, without limitation, a desk, a table, a counter, an operating room rail, or the like, regardless of the tabletop dimensions (e.g., thin- or thick-edged tables). It should be understood that any description herein of the base portion 10 and/or the base plate 12 are for illustrative purposes only and that any suitable means for temporarily, yet securely, attaching “limb positioner” apparatus 2 to a surface is contemplated.

According to embodiments, pedestal 14 may be configured for releasably receiving and/or mounting T-bar connector 16 to base plate 12 and for enabling simple height-adjustment of apparatus 2 relative to the surface. As would be appreciated, in a normal operating environment, the torso of the patient provides a height offset from the surface of the operating table. Herein, pedestal 14 ensures that the height of T-bar connector 16 may be readily adjusted to replicate this offset, regardless of the surgical position being used. For example, pedestal 14 may be configured such that, when T-bar connector 16 is mounted within or to pedestal 14, the height of T-bar connector 16 may be readily adjusted up or down (i.e., extended or retracted within pedestal 14), as desired. It should be understood that any height adjustment of apparatus 2 being manual is for illustrative purposes only and that any suitable means for effectively adjusting the height of apparatus 2 is contemplated.

In some embodiments, pedestal 14 may form a hollow, substantially cylindrical tubular or “barrel” for slidably receiving a solid, substantially cylindrical corresponding “rod” member of T-bar connector 16. Pedestal 14 may also be configured to provide a T-bar connector 16 adjustment means, i.e., for securing T-bar connector 16 in place after adjustment takes place. For example, in some embodiments, pedestal 14 may be configured to form at least one aperture for receiving at least one threaded set screw 11. Set screw 11 may provide a manually rotatable knob that, when rotated clockwise or counterclockwise, may tighten or loosen (respectively), the connection between pedestal 14 and T-bar connector 16 enabling telescopic adjustment of T-bar connector 16 within pedestal 14. In this manner, the present apparatus 2 may accommodate ergonomic access to the system regardless of the height of the work surface and/or the height of the user, whether used in the beach chair or lateral decubitus positions. It should be understood that any description of the presently described height adjustment is for illustrative purposes only and that any suitable means for readily adjusting the height of the apparatus 2 relative to the surface is contemplated. For example, the present height adjustment means might comprise, without limitation, multiple posts of different fixed heights, a single long post in a collar that can be extended or retracted, a single long post with attachment points at different heights, a base that can be raised or lowered, and/or a single fixed height vertical support that could accommodate most users.

According to embodiments, T-bar connector 16 may be configured such that, when slidably positioned within pedestal 14 as described, connector 16 provides access to at least two attachments posts extending substantially perpendicularly one from the other, each post operative to support manipulator arm 20 in one of at least two surgical positions (e.g., where posts represent the approximate 90° offset of the shoulder when the patient is positioned in the beach chair and/or the lateral decubitus positions). That is, as desired, the user may elect to mount manipulator arm 20 to one of the two attachment posts in order to mimic one of the at least two joint orientation positions actually used in an operating room.

In some embodiments, having regard to FIGS. 5, 8 and 9, T-bar connector 16 may provide at least two solid, substantially cylindrical attachment posts. In some embodiments, T-bar connector 16 may be configured to provide at least one first attachment post 13 and at least one second attachment post 15, wherein first and second posts 13,15 extend substantially perpendicularly one from the other. For example, first post 13 may extend substantially vertically along a longitudinal axis a of pedestal 14, and second post 15 may extend substantially horizontally or perpendicularly therefrom. Mounting manipulator arm 20 on first post 13 may be selected to mimic a patient being positioned in the beach chair position (FIG. 1 PRIOR ART), whereas mounting manipulator arm 20 on second post 15 may be selected to mimic a patient being positioned in the lateral decubitus position (FIG. 2 PRIOR ART). In operation, the user may readily select which position to use by simply mounting manipulator arm 20 on the appropriate post 13,15. It should be understood that any description of the presently described T-bar connector 16 and perpendicularly disposed attachment posts 13,15 are for illustrative purposes only and that any suitable means for adjusting manipulator arm 20 of apparatus 2 to mimic actual patient positions conventionally used in an operating room is contemplated.

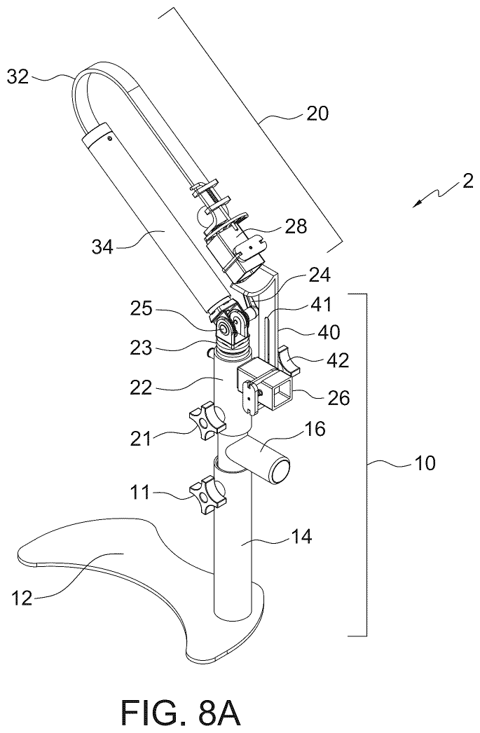

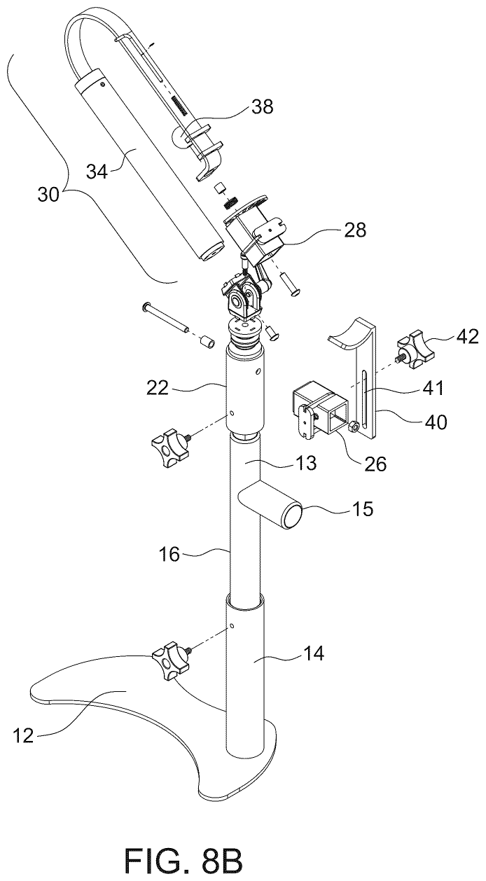

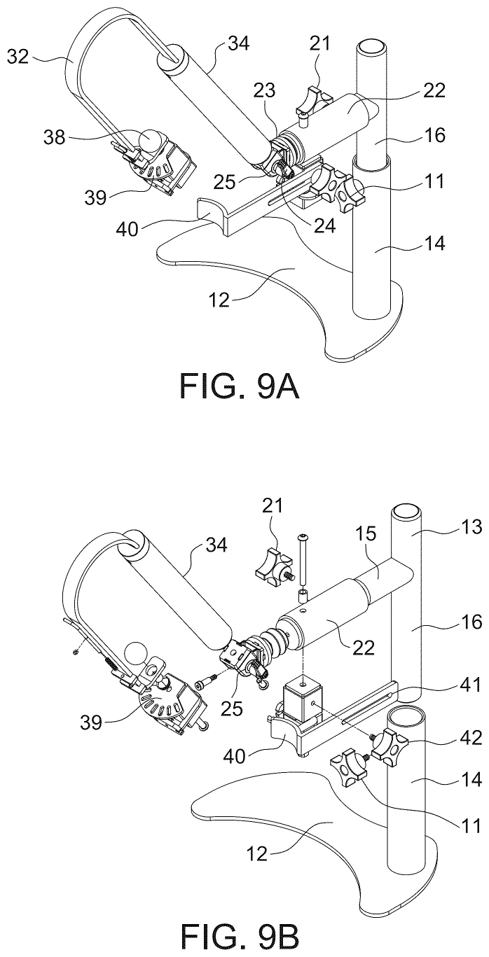

For example, according to embodiments, it is an object of the present apparatus 2 to mimic a realistic operating experience for the user. In this regard, without limitation, at least two embodiments of the apparatus 2 are contemplated, namely, a first embodiment where movement of the “limb positioner” apparatus 2 occurs about a friction joint (see FIGS. 4-6), and a second embodiment where movement of the “limb positioner” apparatus 2 occurs about a hinge or ball joint (which can more closely resemble the natural rotation of a patient's shoulder joint in various degrees of freedom (see FIGS. 8-9), as will be described in more detail.

According to embodiments, embodiments of manipulator arm 20 may be configured to be releasably mounted to base 10 (i.e., via attachment posts 13,15), and may be configured to detachably receive an artificial model 4 of a human joint, such as a shoulder joint. Advantageously, as will be described, manipulator arm 20 allows for at least one actual joint position used in surgery to be mimicked and, once in position, allows for simple, accurate positioning and repositioning of the model 4 (e.g., flexion/extension, abduction/adduction, rotation of the humerus bone about the joint, etc.) as would be performed during surgery.

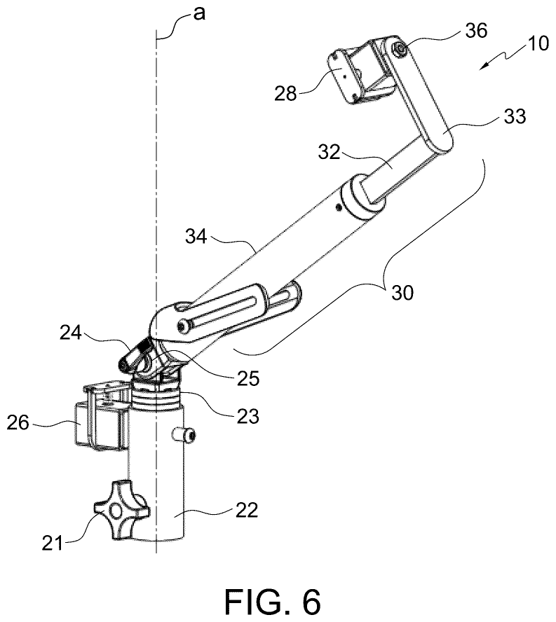

In some embodiments, having regard to FIGS. 6, 8 and 9, manipulator arm 20 may form a tubular or “sleeve” portion 22 having an upper end, a lower end, and a central bore extending therethrough. At its lower end, sleeve 22 may be configured for slidably mounting arm 20 to one of the attachment posts 13,15 (as shown in FIGS. 4 and 8 in the “lateral decubitus” position, and FIG. 9 for the “beach chair” position).

For example, central bore of sleeve 22 may be sized and shaped so as to slidably receive one of posts 13,15 therein. In some embodiments, sleeve 22 may form at least one aperture extending through its sidewall, the aperture configured for receiving at least one threaded set screw 21. Set screw 21 may provide a manually rotatable knob that, when rotated clockwise or counterclockwise, may tighten or loosen (respectively) the connection between arm 20 and base 10, enabling easy positioning of arm 20. It should be understood that sleeve portion 20 is described for illustrative purposes only and that any suitable attachment configuration for readily receiving and stabilizing arm 20 of apparatus 2 is contemplated.

In some embodiments, manipulator arm 20 may be configured for both a rotatable and pivotal connection with sleeve 22. For example, having regard to FIGS. 6, 8 and 9, manipulator arm 20 may comprise a frictional engagement with sleeve 22 (e.g., via a friction joint 23) enabling uninhibited rotation of manipulator arm 20 about longitudinal axis a and relative to sleeve 22. Manipulator arm 20 may comprise a pivotal engagement with sleeve 22 (e.g., via pivot hinge 25) enabling uninhibited pivoting of manipulator arm 20 relative to longitudinal axis a. In this manner, the present apparatus 2 is designed to provide both rotational and pivoting movement of manipulator arm 20 relative to sleeve 22, enabling the user to independently control both the flexion/extension and abduction/adduction ranges of motion.

More specifically, at its upper end, sleeve 22 may be sized and shaped to rotatably connect with manipulator arm 20, enabling easy, rotation of manipulator arm 20 in either a clockwise or counterclockwise direction about longitudinal axis a. As above, having regard to FIGS. 6, 8 and 9, operable connection between manipulator arm 20 and sleeve 22 may comprise at least one friction joint 23, or the like. Friction joint 23 may enable rotation of manipulator arm 20 about axis a allowing the user to mimic flexion and/or extension movement of a patient's arm performed during actual surgery (i.e., movement of the artificial model arm in front of or behind the torso, respectively). In some embodiments, friction joint 23 may be configured in any manner such that, when sufficient load is applied to manipulator arm 20 (e.g., manual load applied by the user), friction force in the joint 23 is overcome and arm 20 can be rotated. Once in a desired position, manual force can be released and frictional engagement force in the joint 23 prevents manipulator arm 20 from inadvertently rotating during use.

Advantageously, the presently described friction joint 23 allows the operator to adjust the position of arm 20 and thus the artificial model 4 by applying manual force to manipulator arm 20, and then securing the position by simply removing the force. The presently described friction joint 23 provides the operator with a smooth positioning experience, such experience being akin to the mechanical positioning arm used during actual surgery, which is not possible with existing cadaveric setups or simulated training model positioners. It should be understood that any description of means for rotatably adjusting manipulator arm 20 relative to sleeve 22 is for illustrative purposes only and that any suitable means for mimicking flexion/extension movement of a shoulder joint during surgery is contemplated. For example, rotation means might comprise, without limitation, a ball joint in combination with locking screw, pins, pressure cups, brake pads, or the like.

At its upper end, sleeve 22 may be also sized and shaped to pivotally connect with manipulator arm 20, enabling easy pivot thereof relative to longitudinal axis a. In some embodiments, having regard to FIGS. 6, 8 and 9, operable connection between manipulator arm 20 and sleeve 22 may comprise at least one pivot joint 25, or the like. Pivot joint 25 may enable free movement of arm 20 about a pivot point allowing the user to mimic abduction movement of the arm (i.e., movement of the arm away from the torso) and adduction movement (i.e., movement of the arm towards the torso) performed during actual surgery. In some embodiments, pivot joint 25 may be configured in any manner such that the user may readily disengage a locking mechanism (e.g., a handle on a screw 24) to pivot manipulator arm 20 into the desired position. Once in the desired position, the locking mechanism 24 may be reengaged, preventing manipulator arm 20 from inadvertently pivoting during use.

Advantageously, locking mechanism 24 may be configured to manipulator arm 20 in the desired position, as the abduction/adduction angle can typically experience the most force applied to the shoulder during surgery. It should be understood that any description of means for pivotally adjusting manipulator arm 20 relative to sleeve 22 is for illustrative purposes only and that any suitable means for operably mimicking abduction/adduction angle movement of a shoulder joint is contemplated. For example, pivot means might comprise, without limitation, a ball joint in combination with locking screw, pins, pressure cups, brake pads, or the like.

According to embodiments, manipulator arm 20 may also form a telescopic boom assembly (referred to generally as 30, with individual componentry being further described herein). In some embodiments, having regard to FIG. 6, boom assembly 30 has a proximal end 31 operably connected to sleeve 22, a distal end 33 operably forming a piston rod 32, and a piston assembly 34 centrally positioned therebetween.

According to embodiments, boom assembly 30 may be configured to provide a tubular piston assembly 34 for applying primary traction to the distal end of a bone of artificial model 4, such as the humerus bone. For example, having regard to FIGS. 6, 8 and 9, boom assembly 30 may provide a spring piston assembly comprising a piston barrel housing a coiled spring therein (not shown), and a piston rod 32 telescopically extending therefrom. Internal piston spring may be mounted in compression such that, when attached to an artificial model 4, piston assembly 34 pulls on a bone of the model, thereby distending the bone. In this manner, apparatus 2 may be configured to account for the offset between the center of rotation of the joint and the center of rotation of the joint of the apparatus 2.

In some embodiments, internal piston spring may be mounted with any suitable compression force to maintain the artificial model 4 in traction. For example, the spring force may be approximately 1.4 lbf/in +/−1 lbf/in, such force, translating to an approximate range of travel of 1-5 inches when applying a primary traction force of approximately 1.4-7 lbf of traction load. It should be understood that any description of means for providing primary traction to an artificial model 4 of a joint is for illustrative purposes only and that any suitable means for mimicking actual surgical supports are contemplated. For example, means of primary traction may include, without limitation, rope/pulleys/weight assemblies and sliding carriage assemblies with locking mechanisms. Rope and pulley assemblies are typically used in actual lateral decubitus positioners but suffer from the drawback of having to use physical weights to apply traction force. Locking carriage assemblies do not have the added weight of the rope/pulley systems but still result in the possibility of too much force being applied and damaging the model if the boom angle is changed without first unlocking the carriage. These drawbacks arise because the shoulder model's axis of rotation is offset from the positioner's axis of rotation. An offset in the axis of rotation means a moment arm moving about one axis will have differing distances between it and the other axis of rotation based on angle.

Alternatively, a floating piston and the locking carriage could be combined to give the benefit of controlling applied traction load while still maintaining the ability of the piston to float. This would be achieved by having the sliding carriage mounted inside the boom at the proximal end of the compression spring. The carriage could then be pushed forward compressing the spring and applying more force without locking the piston itself.

In some embodiments, piston rod 32 may extend from piston assembly 34 and form a substantially U shape. Piston rod 32 may be operably connected to compression spring, such that rod 32 translates the force of compression spring to the artificial model 4 (e.g., to the humerus). Piston rod 32 may also be operably connected to spring, such that rod 32 may telescopingly retract and/or extend within barrel 34 when the abduction/adduction angle of the artificial model 4 is changed. Finally, piston rod 32, may provide means for attaching model 4 to piston assembly 34, such as at least one quick-release adapter (as described below).

In some embodiments, having regard to FIG. 6, piston rod 32 may further comprise at least one piston friction joint 36 for controlling internal and/or external rotation of the artificial model 4 (e.g., rotation of the humerus bone about its own axis. For example, for arthroscopy, this rotation may be approximately +/−30° whereas for arthroplasty, this rotation may need to be at least 180° so as to dislocate the joint. In some embodiments, piston friction joint 36 may be configured such that, when sufficient load is manually applied to piston rod 32, friction force in joint 36 is overcome and rod 32 can be rotated. Once in a desired position, friction force in the joint 36 prevents inadvertent rotation of rod 32 relative to the boom assembly 30. The presently described friction joint 36 provides the user with a smooth positioning experience, such experience being akin to the mechanical positioning arm used during actual surgery or to the positioning provided by a human assistant, which is not possible with existing cadaveric specimen setups or simulated training model positioners.

In other embodiments, having regard to FIGS. 8 and 9, piston rod 32 may alternatively comprise at least one piston slider or ball joint 38 for controlling internal and/or external rotation of the artificial model 4 (e.g., rotation of the humerus bone about its own axis). Piston rod 32 may be substantially U-shaped (e.g., trombone shaped) to allow for a change in length as the model 4 is rotated. In some embodiments, piston ball joint 38 may be configured such that, when sufficient load is manually applied to piston rod 32, friction force in the joint 38 is overcome and rod 32 can be rotated in various degrees of freedom. Once in a desired position, ball joint 38 may be locked in place to prevent inadvertent rotation of piston rod 32 relative to the boom assembly 30. In some embodiments, for example, ball joint 38 may comprise a slotted plate 39, wherein a corresponding extension of piston rod 32 may be slideably received within at least one slot of plate 39 to prevent movement of rod 32. The presently described ball joint 38 provides the user with a smooth positioning experience, such experience being akin to the mechanical positioning arm used during actual surgery, or to the positioning provided by a human assistant, which is not possible with existing cadaveric specimen setups or simulated training model positioners.

In such embodiments, having further regard to FIGS. 8 and 9, manipulator arm 20 may further comprise at least one lateral traction post 40, releasably connected to manipulator arm 20, such traction post 40 for supporting the model 4, e.g., for supporting the humerus bone, which is typically provided by a human assistant in the operating room. In some embodiments, traction post 40 may comprise a slider cam 41 for receiving at least one threaded screw 42, enabling the user to readily adjust the height of and to stabilize the positioning of the humerus bone. It should be understood that the joints provided in the present apparatus 2 may be configured so as to resist rotation of manipulator arm 20 in a manner to mimic the actual resistance felt when rotating a human arm during surgery.

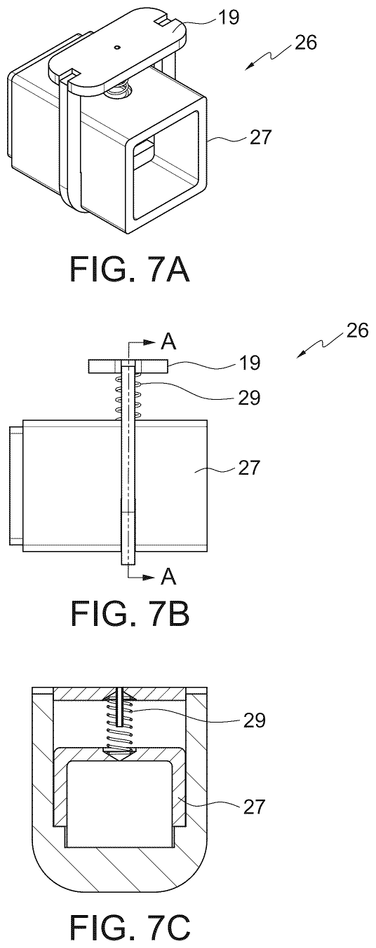

According to embodiments, manipulator arm 20 may be configured to provide an easy, user-friendly connection of the artificial model 4 being mounted thereto. In some embodiments, where the artificial model 4 comprises a shoulder joint, arm 20 may form at least two quick-release adapters 26,28, a first adapter 26 for connecting the scapula of the model 4 to arm 20, and a second adapter 28 for connecting the end of the humerus to arm 20. Adapters 26,28 may provide for the quick release of model 4 to manipulator arm 20 regardless of the surgical position being mimicked. Advantageously, each first and second adapters 26,28 may be configured to ensure stable support of model 4 while still allowing for rotation of the scapula and humerus, providing ergonomic access and enhanced realism of the model. For ease of explanation, any reference to adapters 26 herein (shown in FIG. 7) also applies to adapters 28. It should be appreciated that any description of adapter 26 positioned on apparatus 2 shall include a corresponding connector positioned on model 4.

In some embodiments, having regard to FIGS. 7A-7C, adapters 26 may comprise a spring-loaded box and pin connection. For example, box 27 may be spring-loaded and configured to receive a corresponding pin on the artificial model 4. Box 27 may comprise a hollow, substantially square member having a guide cam or slot extending along an inner surface for directing the pin into place. When engaged, compressive load from the spring 29 secures the pin within box 27. When disengagement is desired, the load may be decompressed (by pressing button 19) and the pin can be removed from box 27. Although adapters 26,28 are described herein as being square in shape, any suitable size/shape/configuration of adapters that achieves the desired result are contemplated.

In some embodiments, adapters 26,28 provide a mating feature between apparatus 2 and any corresponding artificial joint model 4. Adapters 26,28 may be configured to allow positioning of the artificial model 4 with a smooth, single insertion movement, while also preventing inadvertent forward and backward, or rotational, movement of model 4 once in place. Such ease of positioning eliminates the unnecessary anxiety and frustration encountered when positioning conventional cadaver models, which are plagued with over-tightening causing bones to break accidentally, or under-tightening, causing unwanted rotation or slippage of bones. Such ease of positioning also overcomes drawbacks of existing simulated training systems, which require multiple steps to secure the model, and subjective assessment by the operator if the model has been secured using inaccurate thumb screws.

It should be understood that any description of the presently described quick-release adapters are for illustrative purposes only and that any suitable means for adjustably mounting an artificial model 4 to apparatus 2 are contemplated. For example, the present quick-release connection may be achieved using, without limitation, adapters of any size and/or shape to accommodate any model. Moreover, the spring-load box and pin connection may comprise any suitable quick-release pin or plunger configuration known in the art.

According to embodiments, the present apparatus 2 may be configured for easy, releasable attachment to at least one surface for use in orthopaedic surgery training. In some embodiments, the system may comprise at least one adjustable attachment device adapted to temporarily secure the apparatus to the surface, as desired. The at least one attachment device(s) may comprise at least one clamping device (e.g., a C-clamp or G-clamp), or other such suitable device for holding the apparatus in place on the surface. For example, without limitation, attachment device(s) may comprise any suitable attachment means including ratchet clamps, suction cups, weights, ties, OR table rail clamps, or the like. It is contemplated that the at least one connector(s) may or may not be integral to the apparatus.

According to embodiments, the present apparatus 2 may be configured to support at least one artificial joint model 4 mounted thereto. In some embodiments, the artificial joint model 4 may comprise a shoulder model and the apparatus 2 may be configured such that the shoulder model 4 may be easily transitioned between a first “beach chair” position and a second “lateral decubitus” position (or vice versa), as desired. It should be appreciated that the present apparatus 2 may be adapted to operably connect any artificial model 4, such as a synthetic model of a joint that may comprise skin, fat, bones, muscles, tendons, ligaments, cartilage, and/or connecting soft tissue.

In some embodiments, the artificial joint model 4 may optionally comprise an outer layer or sleeve of skin (not shown), which may be used as an initial point of contact and location. In some embodiments, the skin may be configured to provide a realistic tactile feel, while palpating for bony landmarks used for portal placement. For example, the skin may be configured to enable the user to locate the clavicle and acromion, and to distinguish between different parts of the muscle, e.g., between muscle bellies. Advantageously, the skin may be configured to allow a tight, precise fit about the artificial model 4. Such fit may provide for palpating bony landmarks and for accurate portal placement to be visible and for placement, reducing damage to underlying soft tissues. Such fit also enables the skin to have different thicknesses in different locations, eliminating the need for portals to be pre-placed or for the skin to have a uniform profile similar to that of a manikin, as with existing synthetic models.

In some embodiments, skin may be manufactured from a composite material comprising at least two layers. For example, at least one layer of the skin may be manufactured from a material, such as a soft urethane, and/or a silicone material. At least one other layer of the skin may be manufactured from a foam material, such as a low density closed cell foam material. In some embodiments, at least one layer of the composite skin may contain a material operative to soften the skin and provide increased flexibility. For example, at least one layer of the composite skin may comprise an oil material, such as a mineral oil. Advantageously, the at least one oil material may also serve to provide a self-lubricating effect during use of the composite skin, such as when the skin is cut, punctured, or drilled (e.g., with a scalpel, a trocar, a cannula, or other such tool).

In some embodiments, skin may be configured to be removably mounted on model 4. For example, skin may be configured for detachment and reattachment intraoperatively, enabling the operator to check their work and maintain their portal placement during training or to use the skin on another model. It is contemplated, although not necessary, that the skin may be manufactured from materials and according to processes as defined and disclosed in international patent application no. PCT/CA2022/050281, such disclosure being incorporated herein by reference in its entirety.

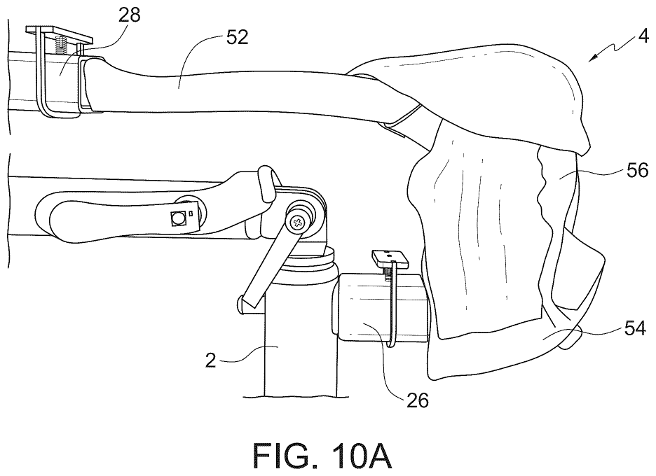

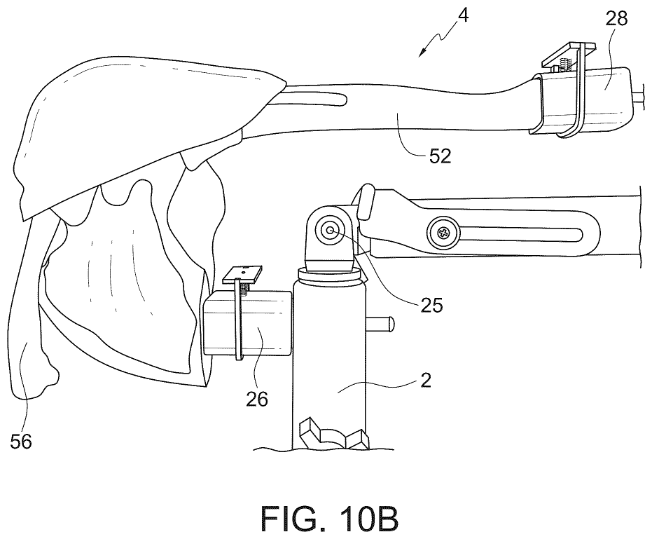

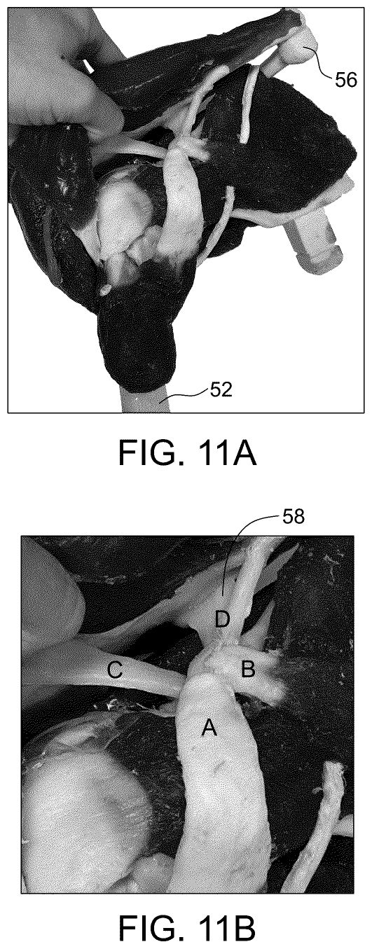

According to embodiments, having regard to FIGS. 10A-10B, and 11A-11B, the artificial joint model 4 may also comprise all appropriate cortical and cancellous bone anatomy such as, without limitation, a humerus 52, scapula 54, acromion (not shown), clavicle 56, glenoid (not shown), and coracoid 58 (FIG. 11A). For example, having regard to FIG. 11B, without limitation, the present model 4 may provide that the conjoined tendon (A) and the pectoral minor (B) and the coracoacromial ligament (C) and coracoclavicular ligament (D) are attached to the coracoid 58. In this manner, advantageously, the present model 4 is rigidly attached to the scapula 54 and the humerus 52. In some embodiments, the synthetic bones may be manufactured from materials and according to processes as defined and disclosed in international patent application no. PCT/CA2021/050729 (WO2021/237367), such disclosure being incorporated herein by reference in its entirety. That is, the synthetic bones may be manufactured from various materials in order to create bones having different hardnesses. Without limitation, in some embodiments, the synthetic bones may be manufactured from an expanding rigid foam (e.g., Foam-it 5) with a large percentage of glycerin (e.g., approximately 20%).

In some embodiments, artificial joint model 4 may be manufactured to comprise a healthy young cortex with a less dense, softer inner cancellous bone. In other embodiments, artificial joint model 4 may be manufactured to comprise an older, arthritic bone. Bone hardness may be specifically configured and designed along the rim of the glenoid, where anchors are inserted as part of labrum repairs, and along the edge of the humeral head for rotator cuff repairs. It should be appreciated that, along with the dimensional bony anatomy, bone density hardness, outer cortex, and inner cancellous structures each play a significant role in orthopaedic surgery training.

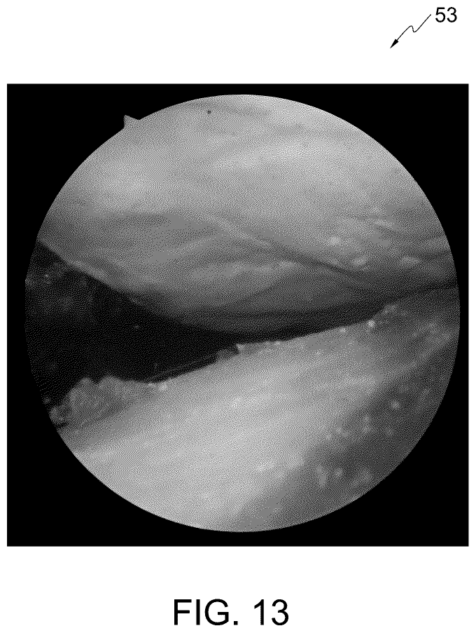

According to embodiments, the artificial joint model 4 may also comprise all appropriate muscle and soft tissues, particularly where the model comprises a shoulder model surrounded by muscles and soft tissues that can play a significant role when making portals to the glenohumeral joint and when working in the subacromial space 53 (FIG. 13). Model 4 may provide specific anatomical features important for training, and may replicate the tactile interactions that occur during actual surgery. In this manner, a dynamic, integrated, orthopaedic training system 10 is provided, the system 100 allowing for a surgical trainee to interact functionally and biomechanically with the artificial model 4 as they would with a real patient, thereby replicating the tactile aspects of the surgery and training the mechanics related to patient positioning to improve the operative experience.

In some embodiments, the artificial joint model 4 may be manufactured to comprise a muscle material configured to be soft, flexible, and easy to cut when in line with muscle fibers in the anteroinferior direction, and difficult to cut when working perpendicular to the muscle fibers. In some embodiments, the artificial joint model 4 may be manufactured to comprise at least one composite material, such as a silicone-based gel material with fibers, such as silk, embedded in the muscle in a laminar direction reminiscent of natural muscle fibers. In some embodiments, the muscle bulk may be made up of multiple smaller muscle bellies, both visually and physically reminiscent of natural muscle.

As would be appreciated, a critical transition occurs from the muscle to the tendons at the musculotendinous junction. Advantageously, the present artificial model 4 may be manufactured to provide a primary muscle material transitioning from a soft silicone to the harder materials of the tendons. In some embodiments, this may be achieved by first casting the tendons with exposed embedded fibers, and then providing a second cast of the muscles with the soft material. The embedded fibers of the junction act as mechanical fasteners strengthening the bond between the muscle and tendon.

The rotator cuff is a common source of injury and repairing it is a common orthopaedic procedure. To repair a torn rotator cuff in a simulated model, the material must be strong enough to retain a suture. Given that the pattern of the tear can vary, a simulated cuff using a flat, multi-directional fiber matrix may be used, minimizing cuff thickness while facilitating suture retention.

Ligaments (as well as tendons and other structures such as the rotator cuff and labrum) consist generally of collagenous fibers embedded in a matrix material, initially providing limited resistance to tension, then becoming increasingly stiff, resulting in a non-linear force-elongation curve. Embedding fibers or other stiffer materials into an artificial ligament helps to mimic both the tactile feel of the ligament itself as well as the combined tactile feel of the entire joint, and helps to resist tearing, cutting or rupture. In some embodiments, the labrum may need to be strong enough to hold sutures under a tension of 10 N to 100 N, but soft enough to receive a needle. In this manner, the labrum may be manufactured by setting a fiber matrix parallel to the desired repair site, reinforcing the labrum material along the suture line.

In some embodiments, model 4 may comprise at least a silk fiber material, such fiber material providing the user with the ability to suture and repair the labrum. When suturing the labrum of existing models, the suture material can be sewn but caution must be taken by the user to not over tighten the suture thread as the material easily tears and does not represent the true surgical feel.

Cartilage is a complex, thin, multilayered structure protecting the surface of joints. The aesthetics are important when using an arthroscope so that it looks and behaves like real cartilage, specifically, that it is soft enough such that it can be deformed with a probe but malleable enough that it returns to its original shape.

In some embodiments, model 4 may comprise at least a resin material, such material being used alone or in combination with other materials, such as mineral oil and/or glycerin. Such materials may be configured to give the simulated cartilage of model 4 the ability to indent, reform into its original shape (i.e., rebound), scuff, and to cut like healthy cartilage. For example, in some embodiments, mineral oil and/or glycerin materials may be used to soften the resin material as well as to act as a lubricant to prevent melting from the friction of saws used during surgical training. In other embodiments, muscles can be configured to be traversed with surgical instruments with sufficient resistance (while leaving minimal residue, i.e., to be reamable) using a combination of embedded fibers, foam, and glycerin.

The rotator interval is a triangular space located in the anterosuperior portion of the glenohumeral joint. It is bounded by the supraspinatus superiorly and the subscapularis inferiorly, and the coracoid process forms its medial base. Contained within this triangular space are the coracohumeral ligament (CHL), middle glenohumeral ligament (MGHL), and superior glenohumeral ligament (SGHL), long head of the biceps tendon, and anterior joint capsule. The space within the ligaments is a thin translucent piece of tissue that allows the top portion of the subscapularis tendon on the other side of the capsule to be visualized. This is a crucial landmark as it allows surgeons to know where to enter the capsule to create their portal for biceps tendon and labrum repairs. The rest of the capsule is opaque and thicker, including the ligaments which are just thickenings of the capsule.

According to embodiments, model 4 may be configured to comprise a unified capsule with multiple thicknesses and varying degrees of opacity, multiple layers of fiber and silicones are built up in specific areas to create this effect. In some surgeries, specifically arthroscopic surgeries, fluids are pumped through the capsule in order to balloon out the capsule making it accessible for surgical tools (vs. arthroplasty where the capsule may be tight), as described in more detail below. Since the shoulder model is a dry model, no fluids are used to assist with this, therefore, starched fibers are added in order for the capsule to maintain its own shape while being scoped. In addition to helping the capsule retain its shape, the added fibers are also important for providing strength to the capsule. When doing a labrum repair, part of the capsule is sutured and attached to the labrum. The capsule is very thin, and without these embedded fibers the suture would pull out, tearing the capsule.

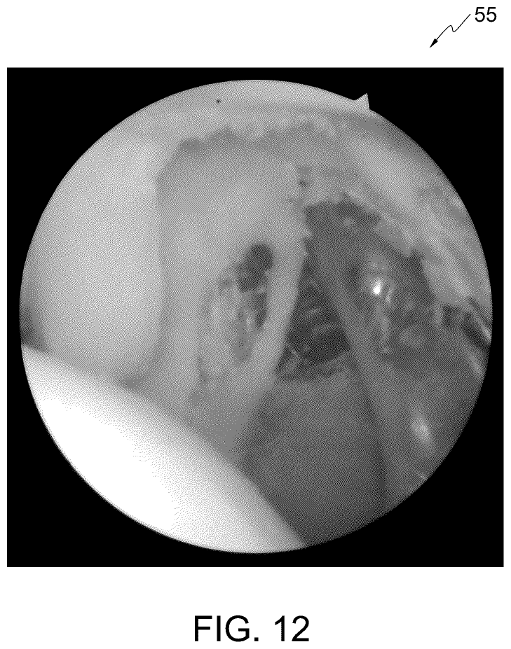

According to embodiments, having regard to FIG. 12, model 4 may be configured to advantageously provide a rotator interval 55, an improved musculotendinous junction, a capsule operative to hold its shape, (e.g., maintain its shape/distension, its fiber orientation, having thicker areas while also being very thin, as applicable), giving the user the ability to perform instability repairs (including labral tears), to perform rotator cuff repairs, to enable anchoring in bone, and to enable suturing of soft tissues. For example, in some embodiments, model 4 may include, in particular, a rotator interval 55, a joint capsule, a musculotendinous junction, a tight or loose joint depending on the surgery being trained, cartilage, a labrum and biceps tendon, and bones of different hardness. In this manner, model 4 may be configured for use as a loose joint (e.g., as for arthroscopic procedures in which fluid typically expands/distends the joint capsule). For example, model 4 may provide an expanded/ballooned joint capsule to mimic the fluid being inside the joint, a stretchable capsule with fewer fibers (and not fibers throughout), such that the user can pull down when suturing the rotator cuff attached to the capsule. Also in this manner, model 4 may be configured for a tight joint (e.g., as for arthroplasty procedures). For example, model 4 may provide a tighter joint capsule that fits tightly within the joint, an intact rotator cuff (no tears), and a capsule having fibers throughout because they need not be stretched. It should be appreciated that such flexibility ensures the present model 4 can be used as a training tool for a variety of pathologies, including customized or rare pathologies. Without limitation, it is contemplated that the rotator cuff may be manufactured by creating a flat, multi-directional fiber material, resulting in a thin cuff that can still hold sutures.

More specifically, the present model 4 may be configured to provide a joint capsule that is thin, yet maintains its shape (without fluid), while being sufficiently robust to cut with a scalpel and to suture. In this manner, in some embodiments, the joint capsule may be manufactured from various materials such as silicone (for the capsule) and urethane (for the bone). For example, in some embodiments, the joint capsule may be manufactured by creating a silicone positive shape and then brushing on a layer of silicone and oil (e.g., mineral oil) to provide a smooth surface that feels less like rubber, plus a thickener to control viscosity. The thickener allows the silicone to fill the variable shape of the capsule positive to create different thicknesses, representing different ligaments. Silk fiber(s) may then be applied for structure, except where the rotator cuff tear is located, such tear location comprising an elastic bandage instead. Another layer of silicone can then be applied to hold and maintain the capsule, using additional oil if needed to smooth the surface. An outer shell is applied over top, with vent for excess material, to ensure that it remains thin. In order to adhere silicone to urethane, the urethane bone can be roughened, and then a silpoxy (which is silicone) can be applied before the silicone. Although certain methods and materials are described herein, such descriptions are for explanatory purposes only and any such methods and materials known in the art to achieve the desired results are contemplated.

As above, in some embodiments, the present model 4 may be configured for surgical training on bone defects as for an arthroscopy or arthroplasty training model, such as, without limitation, a Hill-Sachs lesion on the humerus, which can be repaired either using part of the capsule (a remplissage) or using a bone graft from the coracoid (autograft) or the tibia (allograft), or for performing a Laterjet procedure, or addressing a posterior bone defect on the glenoid. In some embodiments, the present model 4 may be configured for surgical training on a torn rotator cuff, e.g., for an arthroscopy model, or on labral tears (e.g., Bankart lesion, posterior, anterior, and/or superior). In some embodiments, the present model 4 may be configured for surgical training of diagnostic scoping, bicep tenodesis, rotator cuff tears (e.g., crescent, reverse L, L shaped, subscapularis), and glenoid bone grafts (e.g., anterior and/or posterior).

According to embodiments, system 100, configured with the model 4 and limb positioner apparatus 2, comprises synergetic benefits over predicate synthetic models and cadaveric specimens. The system 100 blends the relevant patient anatomy with the structural elements of the positioner 2 to create a realistic intraoperative experience for the user, while minimizing the physical size of the system 100, the complexity of the system 100 setup and the complexity of intraoperative adjustments of the system 100. Predicate synthetic models have paid little attention to this synergistic relationship. Cadaveric specimens and conventional positioners are unable to achieve this synergistic relationship as the behavior of the specimen is unpredictable and variable and held in static positions.

According to embodiments, system 100 may be designed such that all loading conditions and forces applied by the positioner 2, for example primary traction, secondary traction, flexion/extension, abduction/adduction, and internal/external rotation are tuned and calibrated to match the material properties and behavior of the model 4. This balancing of forces and materials properties is not possible with cadaveric training systems and it provides a user experience that is similar to when operating on an actual patient.

The embodiments described herein are intended to be examples only. Alterations, modifications and variations can be affected to the particular embodiments by those of skill in the art. The scope of the claims should not be limited by the particular embodiments set forth herein but should be construed in a manner consistent with the specification as a whole.

All publications, patents and patent applications mentioned in this specification are indicative of the level of skill of those skilled in the art to which this invention pertains and are herein incorporated by reference to the same extent as if each individual publication patent, or patent application was specifically and individually indicated to be incorporated by reference. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A system for use in orthopaedic surgery training on a joint, the system comprising:
an apparatus for supporting at least one artificial model of the joint in at least one joint orientation position, and
at least one artificial model of the joint, releasably mounted to the apparatus, the apparatus configured for pivotal and rotatable movement of the artificial model within the at least one joint orientation position.

2. The system of claim 1, wherein the apparatus may comprise:
a base, and
a manipulator arm mounted to the base, the manipulator arm configured to rotatably and pivotally receive the at least one artificial model of the joint.

3. The system of claim 2, wherein the base further comprises:
a base plate,
a pedestal, and
at least one T-bar connector for receiving and securing the manipulator arm.

4. The system of claim 3, wherein the T-bar connector comprises at least two attachment posts for receiving and securing the manipulator arm in the at least one joint orientation position.

5. The system of claim 2, wherein the manipulator arm further comprises at least one telescoping boom assembly.

6. The system of claim 1, wherein the artificial model is a human joint.

7. The system of claim 6, wherein the human joint is a shoulder joint.

8. The system of claim 1, wherein the at least one joint orientation position comprises at least a beach chair position or a lateral decubitus position.

9. The system of claim 1, wherein the apparatus is further configured to provide loading conditions on the at least one artificial model to mimic primary traction, secondary traction, flexion/extension, abduction/adduction, or internal/external rotation of the at least one artificial model.

10. An apparatus for use in orthopaedic surgery training on a joint, operatively compatible with at least one artificial model of the joint, the apparatus comprising:
a base, and
a manipulator arm mounted to the base, the manipulator arm configured to rotatably and pivotally receive the at least one artificial model of the joint.

11. The apparatus of claim 10, wherein the base further comprises:
a base plate,
a pedestal, and
at least one T-bar connector for receiving and securing the manipulator arm.

12. The apparatus of claim 11, wherein the T-bar connector comprises at least two attachment posts for receiving and securing the manipulator arm.

13. The apparatus of claim 10, wherein the manipulator arm may comprise:
a sleeve for releasably mounting the manipulator arm to the base, and
a boom assembly.

14. The apparatus of claim 13, wherein the boom assembly comprises a spring-biased piston assembly.

15. An artificial model for use in orthopaedic surgery training on a joint, operatively compatible with at least one apparatus for adjustably positioning the artificial model, the model comprising:
at least one connector for releasably connecting the model to the apparatus in at least one surgical position.

16. The model of claim 15, wherein the joint is a human joint.

17. The model of claim 16, wherein the human joint is a shoulder joint.

18. The model of claim 15, wherein the artificial model comprises one or more layers of artificial skin, fat, bones, muscles, tendons, ligaments, cartilage, or connecting soft tissue.

19. The model of claim 17, wherein the model comprises at least a scapula bone and a humerus bone, and one of the at least one connectors connects the scapula bone to the apparatus and another one of the at least one connectors connects the humerus bone to the apparatus.

20. The model of claim 17, wherein the model further comprises at least one of a rotator interval, a joint capsule, a musculotendinous junction, a tight or loose joint, cartilage, a labrum, a biceps tendon, or bones of different hardnesses.
